(19) United States
(12) Patent Application Publication
(10) Pub. No.: US 2016/0258295 A1
(43) Pub. Date: Sep. 8, 2016

(54) TURBINE BUCKET PLATFORM FOR CONTROLLING INCURSION LOSSES

(71) Applicant: General Electric Company, Schenectady, NY (US)

(72) Inventors: Moorthi Subramaniyan, Bangalore (IN); Rohit Chouhan, Bangalore (IN); Prabakaran Modachur Krishnan, Bangalore (IN)

(21) Appl. No.: 14/635,352

(22) Filed: Mar. 2, 2015

(51) Int. Cl. F01D 5/14

(52) U.S. Cl. CPC F01D 5/143; F05D 2220/31; F05D 2220/32; F05D 2240/24; F05D 2240/80; F05D 2260/97

(57) ABSTRACT

Embodiments of the invention relate generally to rotary machines and, more particularly, to the reducing mixing of packing leakage and the main flow of hot gas or steam in gas and steam turbines, respectively. In one embodiment, the invention provides a turbine bucket comprising: a platform portion; an airfoil extending radially outward from the platform portion; and at least one recess extending radially inward into the platform portion, the at least one recess being disposed at an angle relative to a leading edge of the platform portion.

### BACKGROUND OF THE INVENTION

Embodiments of the invention relate generally to rotary machines and, more particularly, to the reducing mixing of packing leakage and the main flow of hot gas or steam in gas and steam turbines, respectively.

As is known in the art, turbines employ rows of buckets on the wheels/disks of a rotor assembly, which alternate with rows of stationary vanes on a stator or nozzle assembly. These alternating rows extend axially along the rotor and stator and allow combustion gasses or steam to turn the rotor as the combustion gasses or steam flow therethrough.

Axial/radial openings at the interface between rotating buckets and stationary nozzles can allow hot combustion gasses or steam to exit the main flow and radially enter the intervening wheelspace between bucket rows. In gas turbines, cooling air or “purge air” is often introduced into the wheelspace between bucket rows. This purge air serves to cool components and spaces within the wheelspaces and other regions radially inward from the buckets as well as providing a counter flow of cooling air to further restrict incursion of hot gasses into the wheelspace. Nevertheless, incursion of combustion gasses or steam into the wheelspaces between bucket rows contributes to decreased turbine efficiency of between about 1% and about 1.5%.

### BRIEF DESCRIPTION OF THE INVENTION

In one embodiment, the invention provides a turbine bucket comprising: a platform portion; an airfoil extending radially outward from the platform portion; and at least one recess extending radially inward into the platform portion, the at least one recess being disposed at an angle relative to a leading edge of the platform portion.

In another embodiment, the invention provides a turbine comprising: a first turbine bucket including: a first platform portion; a first airfoil extending radially outward from the first platform portion; and at least one recess extending radially inward into the first platform portion, the at least one recess being disposed at an angle relative to a leading edge of the first platform portion; and a second turbine bucket including: a second platform portion; a second airfoil extending radially outward from the second platform portion; and at least one recess extending radially inward into the first platform portion, the at least one recess being disposed at an angle relative to a leading edge of the second platform portion.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic cross-sectional view of a portion of a known gas turbine;

FIG. 2 shows a perspective view of the gas turbine of FIG. 1;

FIG. 3 shows a perspective view of a pair of turbine buckets according to an embodiment of the invention;

FIG. 4 shows a radially-inward looking schematic view of turbine buckets according to an embodiment of the invention;

FIG. 5 shows the turbine buckets of FIG. 4 in relation to hot gas flow; and

FIG. 6 shows a schematic view of a steam turbine bucket according to en embodiment of the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION OF THE INVENTION

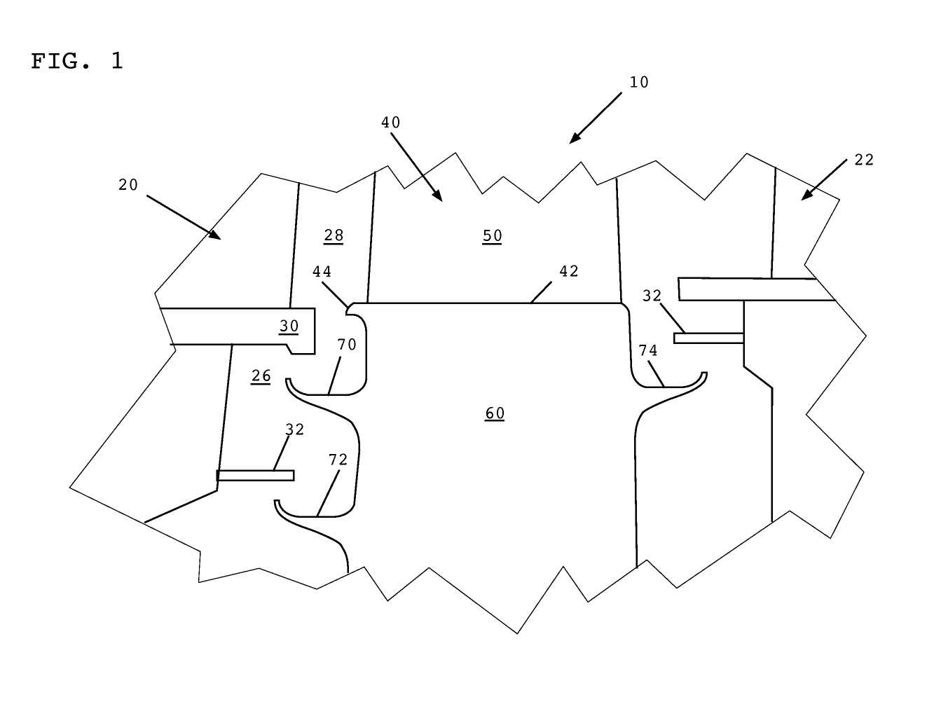

Turning now to the drawings, FIG. 1 shows a schematic cross-sectional view of a portion of a gas turbine 10 including a bucket 40 disposed between a first stage nozzle 20 and a second stage nozzle 22. Bucket 40 extends radially outward from an axially extending rotor (not shown), as will be recognized by one skilled in the art. Bucket 40 comprises a substantially planar platform 42, an airfoil extending radially outward from platform 42, and a shank portion 60 extending radially inward from platform 42.

Shank portion 60 includes a pair of angel wing seals 70, 72 extending axially outward toward first stage nozzle 20 and an angel wing seal 74 extending axially outward toward second stage nozzle 22. It should be understood that differing numbers and arrangements of angel wing seals are possible and within the scope of the invention. The number and arrangement of angel wing seals described herein are provided merely for purposes of illustration.

As can be seen in FIG. 1, nozzle surface 30 and discourager member 32 extend axially from first stage nozzle 20 and are disposed radially outward from angel wing seals 70 and 72, respectively. As such, nozzle surface 30 overlaps but does not contact angel wing seal 70 and discourager member 32 overlaps but does not contact angel wing seal 72. A similar arrangement is shown with respect to discourager member 32 of second stage nozzle 22 and angel wing seal 74. In the arrangement shown in FIG. 1, during operation of the turbine, a quantity of purge air may be disposed between, for example, nozzle surface 30, angel wing seal 70, and platform lip 44, thereby restricting both escape of purge air into hot gas flowpath 28 and incursion of hot gasses from hot gas flowpath 28 into wheelspace 26.

While FIG. 1 shows bucket 40 disposed between first stage nozzle 20 and second stage nozzle 22, such that bucket 40 represents a first stage bucket, this is merely for purposes of illustration and explanation. The principles and embodiments of the invention described herein may be applied to a bucket of any stage in the turbine with the expectation of achieving similar results.

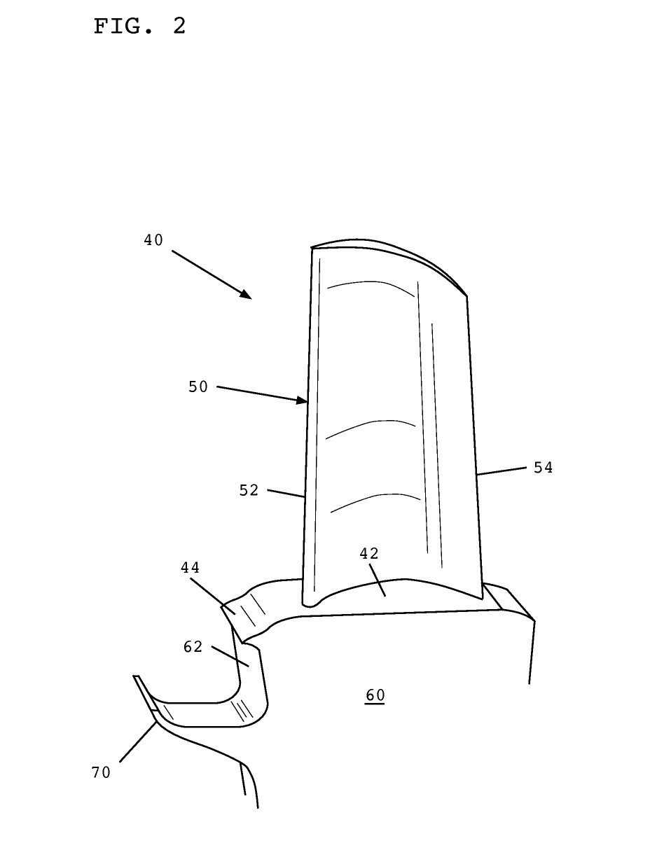

FIG. 2 shows a perspective view of a portion of bucket 40. As can be seen, airfoil 50 includes a leading edge 52 and a trailing edge 54. Shank portion 60 includes a face 62 nearer leading edge 52 than trailing edge 54, disposed between angel wing 70 and platform lip 44.

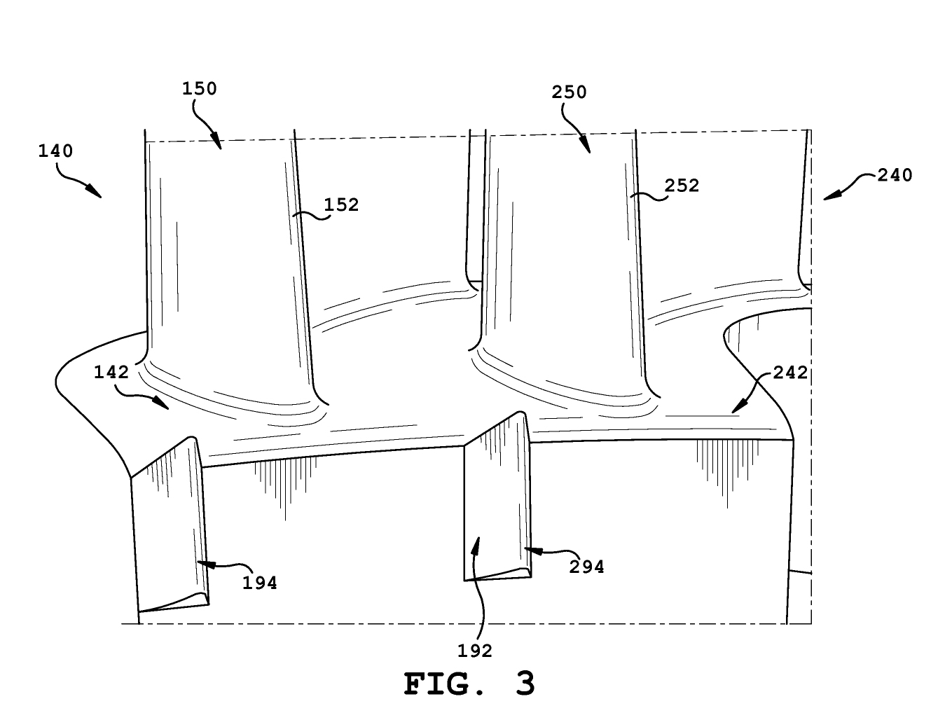

FIG. 3 shows a perspective view of a pair of buckets 140, 240 according to an embodiment of the invention. Here, bucket 140 includes a pair of recesses 192, 194 along platform 142 adjacent leading edge 152 of airfoil 150. Specifically, platform 142 includes an upstream recess 192 and a downstream recess 194. Platform 242 includes a downstream recess 294 along platform 242 adjacent leading edge 252 of airfoil 250 and upstream recess 192 of bucket 140.

Recesses 192, 194, 294 may be machined into platforms 142, 242 according to any known or later-developed method. Alternatively, recesses 192, 194, 294 may be cast as part of platforms 142, 242.

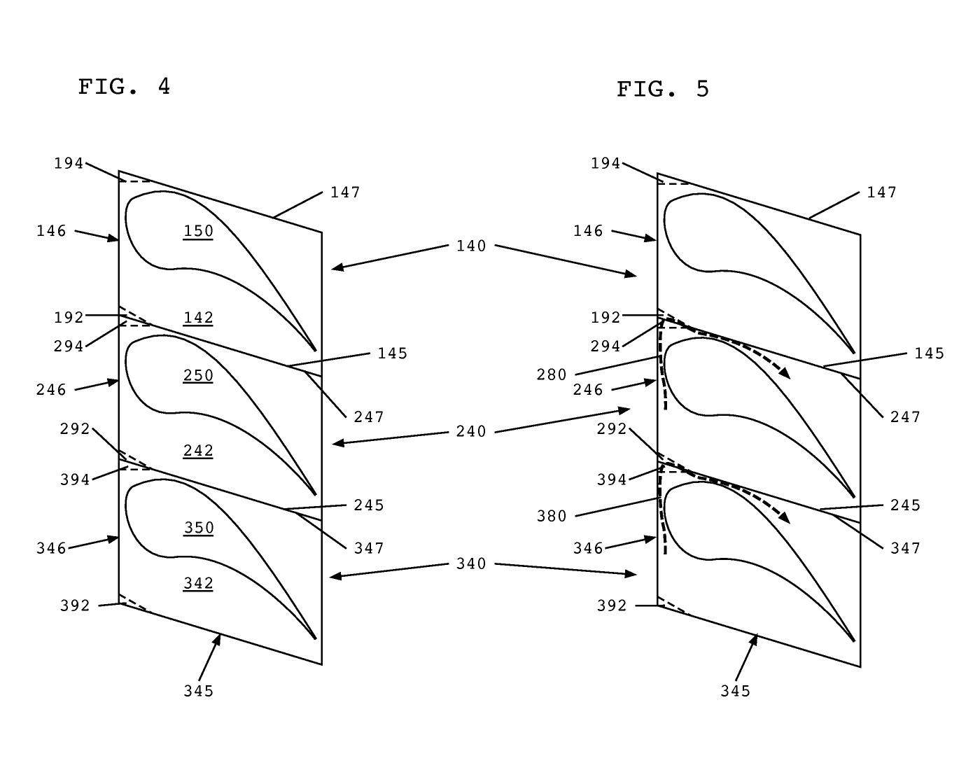

FIG. 4 shows a radially-inward looking schematic view of three buckets 140, 240, 340 according to an embodiment of the invention. As in FIG. 3, upstream recess 192, extends from leading edge 146 to upstream edge 145 of platform 142. Upstream recess 192 is adjacent downstream recess 294, which extends from leading edge 246 to downstream edge 247 of platform 242. Similarly, upstream recess 292 extends from leading edge 246 to upstream edge 245 of platform 242. Upstream recess 292 is adjacent downstream recess 394, which extends from leading edge 346 to downstream edge 347 of platform 342.

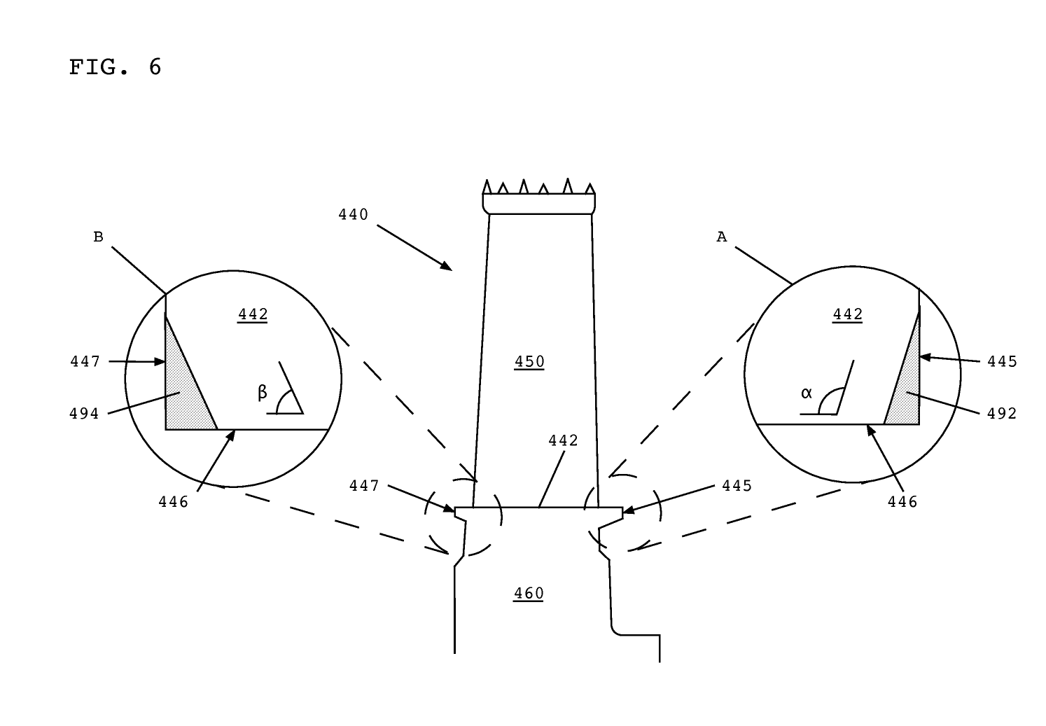

FIG. 5 shows a radially-inward looking schematic view of buckets 140, 240, 340 with respect to the flow of hot gas 280, 380. Recesses 192, 294, 292, 394 alter the flow of hot gas 280, 380. Specifically, recesses 192, 294, 292, 394 act to alter a swirl of hot gas 280, 380, which is directed around a leading face 253, 353 of airfoils 250, 350, respectively. Directing hot gas 280 around leading face 253 of airfoil 250 reduces incursion of hot gas 280 between platforms 142 and 242 and into wheelspace 26 (FIG. 1). The reduction in incursion of hot gas 280 into wheelspace 26 improves turbine efficiency. Typically, turbine efficiency is improved by up to about 0.08% where recesses according to embodiments of the invention are employed in high-pressure and/or intermediate-pressure stages of a gas turbine.

The extent to which the swirl of hot gas 280, 380 is altered depends, for example, on the depth to which recesses 192, 294, 292, 394 extend radially inward into platforms 142, 242, 342. Typically, recesses 192, 294, 292, 394 extend radially inward into platforms 142, 242, 342 to a depth up to about 100 mil (i.e., about 0.1 inch), e.g., to a depth between about 10 mil and about 100 mil, or between about 20 mil and about 90 mil, or between about 30 mil and about 80 mil, or between about 40 mil and about 70 mil, or between about 50 mil and about 60 mil.

Similarly, the extent to which the swirl of hot gas 280, 380 is altered depends on the angles at which recesses 192, 294, 292, 394 are disposed relative to platform leading edges 146, 246, 346. Upstream recesses 192, 292, 392 are typically angled between about 45° and about 80° relative to platform leading edges 146, 246, 346. Downstream recesses 194, 294, 394 are typically angled between about 90° and about 120° relative to platform leading edges 146, 246, 346. As described herein and as shown in FIGS. 3-5, the angles of recesses 192, 294, 292, 394 are angled as measured from upstream edge 145, 245, 345.

The principle of operation of the platform recesses described above with respect to the operation of gas turbines may is also applicable to the operation of steam turbines. For example, FIG. 6 shows a schematic side view of a steam turbine bucket 440 according to an embodiment of the invention. Magnified views A and B show radially-inward looking views of platform 442 adjacent, respectively, upstream edge 445 and downstream edge 447. In magnified view A, upstream recess 492 is shown angled at angle α relative to leading edge 446. In magnified view B, downstream recess 492 is shown angled at angle β relative to leading edge 446.

As noted above with respect to FIGS. 3-5, upstream recess 492 and downstream recess 494 extend radially inward into platform 442 to a depth up to about 100 mil, e.g., to a depth between about 10 mil and about 100 mil, or between about 20 mil and about 90 mil, or between about 30 mil and about 80 mil, or between about 40 mil and about 70 mil, or between about 50 mil and about 60 mil. Increases in the efficiencies of steam turbines employing platform recesses according to embodiments of the invention are similar to those described above with respect to gas turbines. Typically, increases in efficiency of up to about 0.08% are observed.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A turbine bucket comprising:
a platform portion;
an airfoil extending radially outward from the platform portion; and
at least one recess extending radially inward into the platform portion, the at least one recess being disposed at an angle relative to a leading edge of the platform portion.

2. The turbine bucket of claim 1, wherein the at least one recess extends radially inward into the platform portion to a depth up to about 100 mil.

3. The turbine bucket of claim 1, wherein the at least one recess extends from a leading edge to an upstream edge of the platform portion.

4. The turbine bucket of claim 3, wherein the at least one recess is angled between about 45° and about 80° relative to the leading edge of the platform portion.

5. The turbine bucket of claim 1, wherein the at least one recess extends from a leading edge to a downstream edge of the platform portion.

6. The turbine bucket of claim 5, wherein the at least one recess is angled between about 90° and about 120° relative to the leading edge of the platform portion.

7. The turbine bucket of claim 1, wherein the at least one recess includes:
an upstream recess extending from a leading edge to an upstream edge of the platform portion; and
a downstream recess extending from the leading edge to a downstream edge of the platform portion.

8. The turbine bucket of claim 7, wherein the upstream recess is angled between about 45° and about 80° relative to the leading edge of the platform portion.

9. The turbine bucket of claim 7, wherein the downstream recess is angled between about 90° and about 120° relative to the leading edge of the platform portion.

10. The turbine bucket of claim 1, wherein, in an operative state, the at least one recess is adapted to change a swirl of hot gas passing across the platform portion.

11. A turbine comprising:
a first turbine bucket including:
a first platform portion;
a first airfoil extending radially outward from the first platform portion; and
at least one recess extending radially inward into the first platform portion, the at least one recess being disposed at an angle relative to a leading edge of the first platform portion; and
a second turbine bucket including:
a second platform portion;
a second airfoil extending radially outward from the second platform portion; and
at least one recess extending radially inward into the first platform portion, the at least one recess being disposed at an angle relative to a leading edge of the second platform portion.

12. The turbine of claim 11, wherein the at least one recess of the first platform portion includes an upstream recess extending from a leading edge to an upstream edge of the first platform portion.

13. The turbine of claim 11, wherein the upstream recess is angled between about 45° and about 80° relative to the leading edge of the first platform portion.

14. The turbine of claim 12, wherein the at least one recess of the second platform portion includes a downstream recess extending from a leading edge to a downstream edge of the second platform portion.

15. The turbine of claim 14, wherein the downstream recess is angled between about 90° and about 120° relative to the leading edge of the second platform portion.

16. The turbine of claim 14, wherein the upstream recess is disposed adjacent the downstream recess.

17. The turbine of claim 11, wherein the at least one recess of the first platform portion includes at least one recess extending radially inward into the first platform portion to a depth up to about 100 mil.

18. The turbine of claim 11, wherein, in an operative state, the at least one recess of the first platform portion and the at least one recess of the second platform portion are adapted to change a swirl of hot gas passing across the platform portion.

19. The turbine of claim 11, wherein, in an operative state, the at least one recess of the first platform portion and the at least one recess of the second platform portion are adapted to direct hot gas around a leading face of the first airfoil.

20. The turbine of claim 11, wherein, in an operative state, the at least one recess of the first platform portion and the at least one recess of the second platform portion are adapted to reduce hot gas passing radially inward between the first platform portion and the second platform portion.
